(19) United States
(12) Patent Application Publication
(10) Pub. No.: US 2008/0276161 A1
(43) Pub. Date: Nov. 6, 2008

(54) Spreadsheet Rotating Cell Object

(76) Inventor: James Matthew Slavens, Lakewood, CO (US)

Correspondence Address: JAMES M. SLAVENS, 1160 PIERCE STREET, # 202, LAKEWOOD, CO, 80214, US

(21) Appl. No.: 11/673,559

(22) Filed: Feb. 10, 2007

(51) Int. Cl. G06F 17/00

(52) U.S. Cl. 715/213

(57) ABSTRACT

The Spreadsheet Rotating Cell Object provides an improvement to computer software spreadsheets which gives the computer user the ability to invoke the aid of an animated rotating cell object which rotates new data or data representations in and out of the spreadsheet cell.

### BACKGROUND OF THE INVENTION

Almost since the invention of the personal computer, computer software spreadsheets have been powerful applications for users to view, arrange, manipulate and store data.

Spreadsheet software or applications are relatively well-known and useful tools. Typical spreadsheet applications simulate physical spreadsheets by capturing, displaying, and manipulating data arranged in rows and columns. The intersecting rows and columns create numerous cells within the spreadsheet. Typically, each cell may contain an item of data and/or a mathematical formula. In the past, users of computer software spreadsheets typically entered data or data representations directly into each cell. Other methods to provide data and representations to the cell included copying and pasting the contents from one cell to another or from another copy able data source, importing data from another source, or linking one cell to another source so that when the contents of the source changed so too would the contents of the linked cell. Some spreadsheet software or applications provided a general entry area which would show a full-length representation of a selected cell. Later, more flexibility was gained by certain forms of cell data validation, or restrictions which provide selection from a pre-defined, limited list of values where no other values could be entered into the cell, except from those on the list. Also, cells and blocks of cells could receive alternate data using scenarios and “what-it” analysis functions within popular spreadsheet programs; but these functions while useful required additional interfaces, screens and menus, and alternate data was typically hand entered. Animated manipulation of individual cells and contents has not been provided for spreadsheets until this invention. Prior art is referenced, in the following United States of America patents:

U.S. Pat. No. 5,021,973 April 1989 Hernandez et al. (IBM assignee: A typical computer software spreadsheet.)
U.S. Pat. No. 6,282,551 July 1998 Anderson et al. (Borland Software Corporation assignee: Computer software spreadsheet page objects.)
U.S. Pat. No. 5,880,742 November 1996 Rao et al. (Xerox-Corporation assignee: An improvement to a spreadsheet.)
U.S. Pat. No. 6,779,151 January 2001 Cahill et al. (Microsoft Corporation assignee: Storing objects in a spreadsheet.)
U.S. Pat. No. 6,701,485 June 1999 Igra et al. (Microsoft Corporation assignee: Binding spreadsheet cells to objects.)
U.S. Pat. No. 5,371,675 June 1992 Greif et al. (Lotus Development Corporation assignee: Spreadsheet validation sources.)
U.S. Pat. No. 6,438,565 February 1996 Ammirato et al. (Borland Software Corporation assignee: Spreadsheet scenarios.

### BRIEF SUMMARY OF THE INVENTION

This invention takes the prior art to the next level, providing the animated rotating in of data from a variety of possible sources. Users can conveniently hypothesize changes to data in a cell, as well as other related cells by rotating differing data into that cell. This differing data can be entered, linked, or calculated, and the user can change the sets of data being rotated into the cell. Finally, a major improvement provided by the invention is that multiple cells can experience rotations of varying data together to create significant improvements in testing and hypothetical data changing alternatives and user convenience.

The invention is beneficial to spreadsheet users who wish to easily test alternating effects of varied data, as provided to a cell or cells in a spreadsheet. An example effect could include testing informative values of displayed data from a different organization or departments. Another effect could be to display differing results upon adjacent data, when alternating data is introduced to a cell. The value here is that many, multiple alternating data representations can be easily rotated in for differing effects—and the original or prior contents can be easily rotated back in to review an alternative already considered. The invention will be highly useful in testing mathematical and scientific hypotheses, business planning and projections, and daily spreadsheet use.

Like most other items in a spreadsheet this invention is an object and can be directly addressable via computer programming language or macros.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, to the following detailed description of presently exemplary embodiments of the invention, and to the appended claims.

### BRIEF DESCRIPTION OF THE SEVERAL VIEWS OF THE DRAWING

In the drawings, which form a part of this specification,

FIG. 1 is a view with a 3-sided horizontal example with 3 contents, having two of the contents visible in mid rotation;

FIG. 1A is a view after the horizontal rotation in FIG. 1 is completed;

FIG. 2 is a view with a 6-sided horizontal example with 6 contents, having three of the contents visible in mid rotation;

FIG. 2A is a view after the horizontal rotation in FIG. 2 is completed;

FIG. 3 is a view with a 3-sided vertical example with 3 contents, having two of the contents visible in mid rotation;

FIG. 3A is a view after the vertical rotation in FIG. 3 is completed;

FIG. 4 is a functional diagram illustrating a computer environment and computing device operable to provide a task helper according to the present invention;

FIG. 5 is a view of an example secondary visual graphic providing a user of the invention with information and user-manipulated settings including number of rotating sides, sources of data, properties and other important settings;

FIG. 6 is a view of five horizontal instances of the invention manipulated together in unison, and

FIG. 7 is a view of seven vertical instances of the invention manipulated together in unison.

### DETAILED DESCRIPTION OF THE INVENTION

Although the invention has been described in connection with a preferred embodiment, it should be understood that various modifications, additions and alterations may be made to the invention by one skilled in the art without departing from the spirit and scope of the invention as defined in the appended claims.

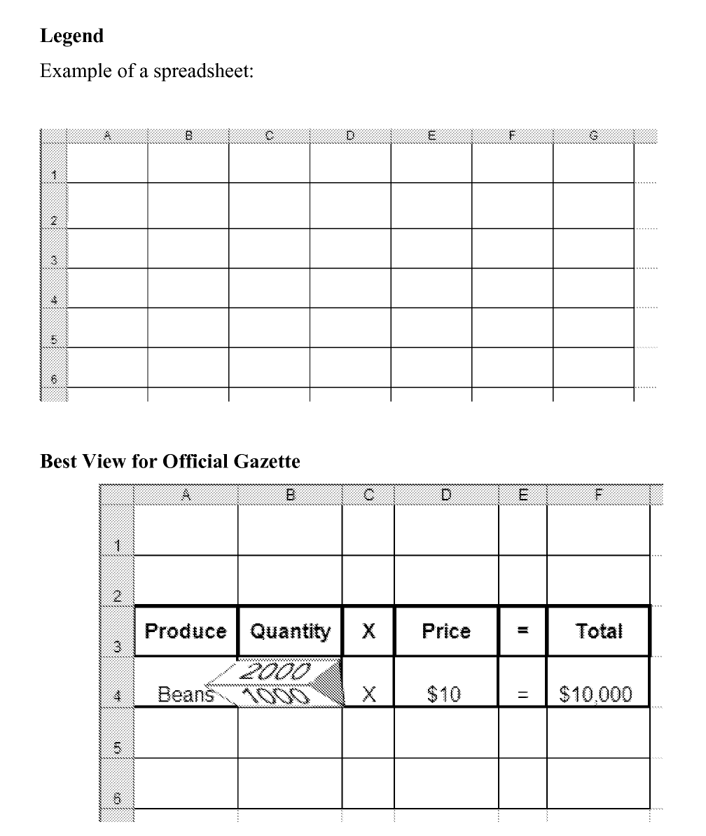

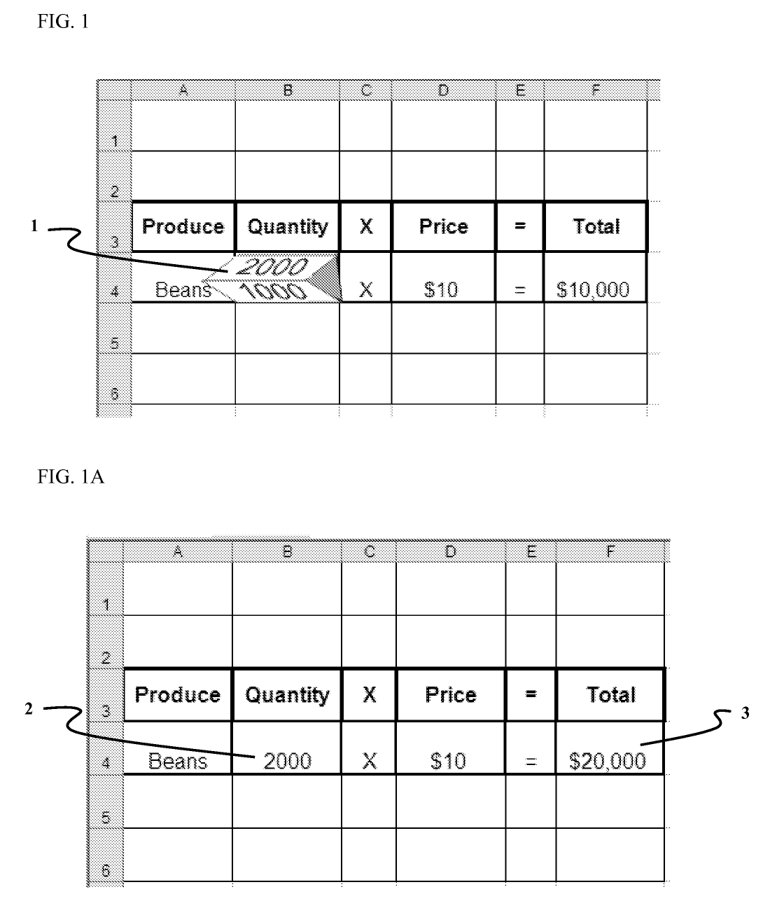

With reference to the drawings and, in particular, with reference to FIG. 1 the invention may be activated, by user control using menu or by a computer input device, as an animated, 3-dimensional geometric rotating cell object, which provides the capability to alternately, display and functionally contain multiple contents 1 upon multiple surfaces of the object, including text, values or representations, such as formulas, wherein after rotation one of the contents is visible and used by the spreadsheet 2 and 3, and through program or user manipulation other, alternate content may be rotated in to be visible and used by the spreadsheet. Though not indicated in FIG. 1, top-to-bottom or bottom-to-top would be the direction of rotation for the horizontal instance.

As best seen in FIG. 1A a horizontal rotation is completed where the Quantity figure of 2000 was rotated in to be the cell contents 2, and the quantity figure of 20,000 is the related mathematical result from the change 3.

An important feature of the invention includes that data that has already been rotated in and subsequently rotated out in favor of other data may also be rotated back in.

Multiple contents of a single instance of the invention can have differing data sources, having one side being supplied by one data source, and other sides being supplied by data from other sources. An example could include sales results from Region 1's server could supply one side while sales results from other region's servers supply other sides of the invention. Data sources can include but not be limited to, user entry, representations such as formulas, other spreadsheets that are grouped in the same spreadsheet application file as the spreadsheet using the invention, other cells on the same spreadsheet, spreadsheets located in another file, other external data application programs, text files, calculations and programming code.

Once established in a cell, the invention has the capability to be bypassed or not used, so that alternate direct entry or other normal operations of the cell are still available to the user.

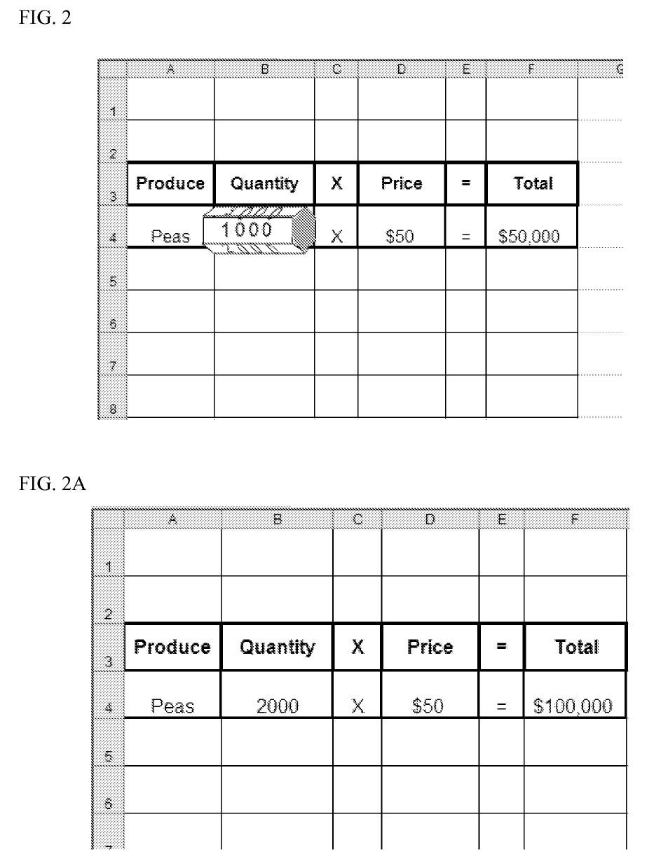

An unlimited number of sides may be selected for use. FIG. 2 indicates generally an example with 6 sides.

A single instance of the invention has settings, programming methods and properties available to manipulate and address features of the invention.

FIG. 2A indicates a view after the horizontal rotation in FIG. 2 is completed. The count of graphic sides of the invention can be fewer than the count of data representations supplying the invention, with the invention rotating through high counts of data sets, while showing a limited number of graphic sides. Multiple data contents of the invention sides can be addressed, controlled, and used whether visible to the user or not.

Upon changing the contents of one or more of the sides of the invention using a secondary source, such as but not limited to user direct entry, the invention may be set up to ultimately change the primary linked data directly to the original source and conversely the invention may be set up to prohibit changes to the primary linked data source.

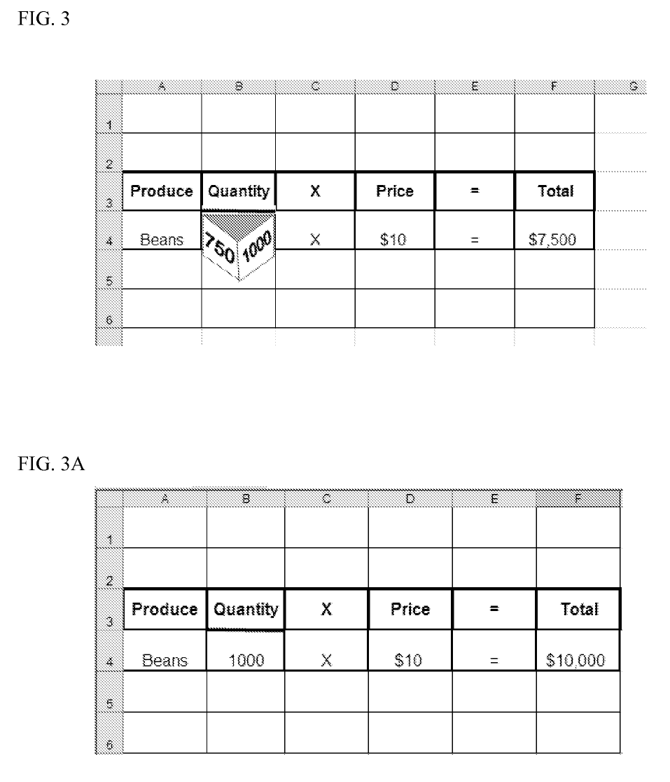

Rotation will occur either horizontally or vertically and the invention can have an unlimited number of sides with FIG. 3 indicating a 3-sided vertical example with 3 contents, having two of the contents visible in mid rotation with FIG. 3A indicating a view after the vertical rotation in FIG. 3 is completed. Though not indicated in FIG. 3, right-to-left or left-to-right would be the direction of rotation for the vertical instance.

An established instance of the invention may be copied and duplicated elsewhere and the invention has the capability to be operated on by outside influences including activities in other cells, other spreadsheets, programming, and setup functions where conditional events within the spreadsheet file have the capability to initiate rotation automatically. For example, if a source cell is changed by the user and exceeds a certain value, automatic rotation of the invention for another cell may be invoked to create chains of scenario activity. Here, for further illumination, if a salesman exceeds a quota significantly in one cell, a different commission percentage may automatically rotate in to another cell, to properly calculate and represent a company's compensation policy.

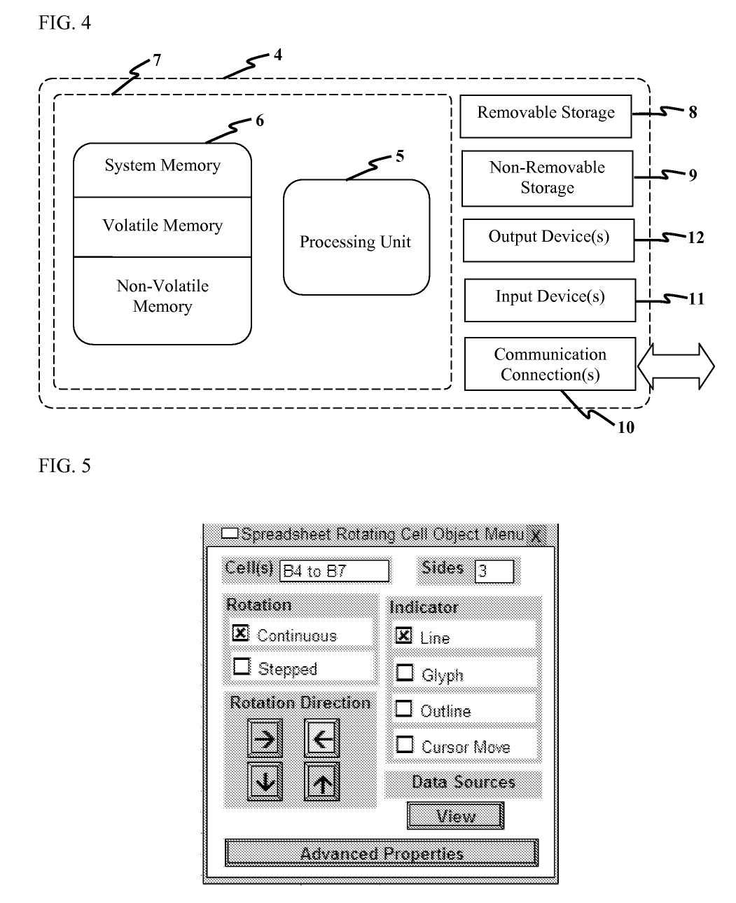

An embodiment of a suitable operating environment in which the present invention may be implemented is shown in FIG. 4. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

With reference to FIG. 4, an exemplary computing environment for implementing the embodiments of the present invention includes a computing device, such as computing device 4. In its most basic configuration, computing device 4 typically includes at least one processing unit 5 and memory 6. Depending on the exact configuration and type of computing device 4, memory 6 may be volatile (such as RAM), non-volatile (such as ROM, flash memory, etc.), or some combination of the two. This most basic configuration of the computing device 4 is illustrated in FIG. 4 by dashed line 7.

Additionally, device 4 may also have additional features/functionality. For example, device 4 may also include additional storage (removable and/or non-removable) including, but not limited to, magnetic or optical disks or tape. Such additional storage is illustrated in FIG. 4 by removable storage 8 and non-removable storage 9. Such computer storage media includes volatile and nonvolatile, removable and non-removable media implemented in any method or technology for storage of information such as computer readable instructions, data structures, program modules, or other data. Memory 6, removable storage 8, and non-removable storage 9 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which can be used to store the desired information and which can be accessed by device 4 and processor 5. Any such computer storage media may be part of device 4.

Device 4 may also contain communications connection(s) 10 that allow the device to communicate with other devices. Communications connection(s) 10 is an example of communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

Device 4 may also have input device(s) 11 such as keyboard, mouse, pen, voice input device, touch input device, etc. Output device(s) 12, such as a display, speakers, printer, etc., may also be included. These devices, either individually or in combination can form the user interface used to display the spreadsheet application with the expandable formula bar as described herein. All these devices are well know in the art and need not be discussed at length here.

Computing device 4 typically includes at least some form of computer readable media, which can be some form of computer program product. Computer readable media can be any available media that can be accessed by processing unit 5. By way of example, and not limitation, computer readable media may comprise computer storage media and communication media. Computer storage media includes volatile and nonvolatile, removable and non-removable media implemented in any method or technology for storage of information such as computer readable instructions, data structures, program modules, or other data. Combinations of the any of the above should also be included within the scope of computer readable media.

The user will have control of the setup of the invention; FIG. 5 is a view of only one example of a secondary visual graphic providing a user of the invention with information and user-manipulated settings including number of rotating sides, sources of data, properties and other important settings.

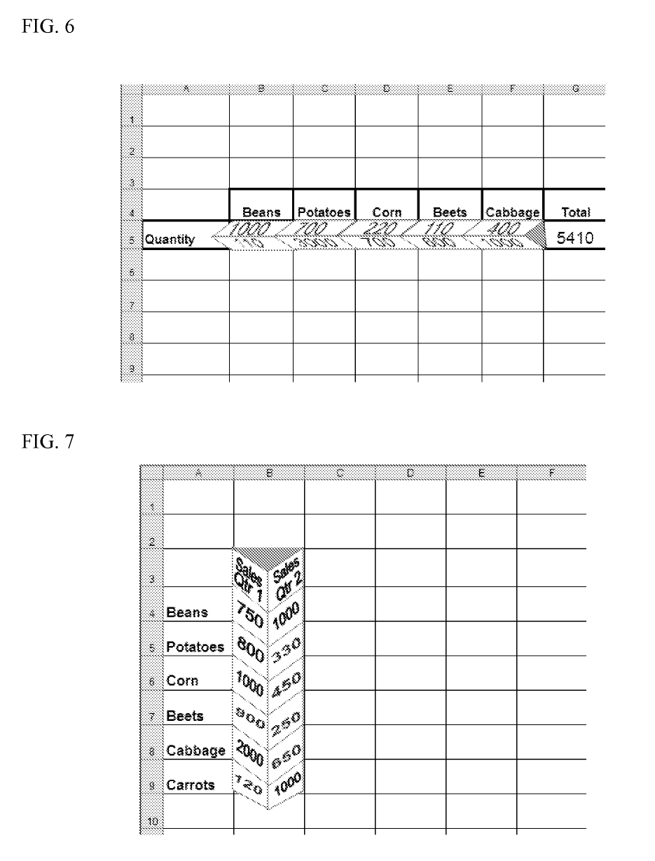

Multiple instances of the invention can be available and used on a single spreadsheet being placed adjacent or non-adjacent to one another. Multiple instances of the invention may be operated upon collectively, manipulated together in unison having whole ranges of cells rotating together as shown in FIG. 6 and FIG. 7. Multiple instances of the invention as collected together will have programming methods and properties available to manipulate and address features of the associated, multiple instances of the invention

The embodiments of the invention in which an exclusive property or privilege is claimed are defined as follows:

1. I claim: An animated rotating cell object, addition to a computing system software spreadsheet application which provides the capability to rotate data or data representations in and out of a spreadsheet cell,
wherein said animation will be of the form of a three-dimensional geometrical object which appears on top of a related spreadsheet cell and said animation disappears when one of the surfaces or sides is selected,
wherein through program or user manipulation other, alternate content contained on alternate surfaces of the object will be rotated in to be visible and used by the spreadsheet cell,
wherein after rotation one of the contents is visible and used by the spreadsheet cell,
wherein rotation may be preset to occur either horizontally or vertically,
wherein for horizontal instances top-to-bottom or bottom-to-top rotation may be used and for vertical instances right-to-left or left-to-right rotation may be used,
wherein two or more, up to an an unlimited number of sides may be preset,
wherein multiple instances of the invention can be available and used on a single spreadsheet being placed adjacent or non-adjacent to one another, and
wherein said multiple contents of a single instance of the invention can have differing data sources, having one side being supplied by one data source, and other sides being supplied by data from the same or other sources.

2. The invention of claim 1, wherein rotation is accomplished by user control using menu or other graphic manipulations by a computing system input device.

3. The invention of claim 1, wherein data that has already been rotated in and subsequently rotated out in favor of other data, can also be rotated back in.

4. The invention of claim 1, wherein data sources can include but not be limited to, user entry, representations such as formulas, other spreadsheets that are grouped in the same spreadsheet application file as the spreadsheet using the invention, other cells on the same spreadsheet, spreadsheets located in another file, other external data application programs, text files, calculations and programming code.

5. The invention of claim 1, wherein the multiple data content of the invention sides can be addressed, controlled, and used whether visible to the user or not.

7. The invention of claim 1, wherein a single instance of the invention, has settings, programming methods and properties available to manipulate and address features of the invention.

12. The invention of claim 1, wherein the invention contains the capability to be operated on by outside influences including activities in other cells, other spreadsheets, programming, and setup functions where conditional events within the spreadsheet file have the capability to initiate rotation automatically.

13. The invention of claim 1, wherein the invention, once established in a cell, contains the capability to be bypassed or not used, so that alternate direct entry or other normal operations of the cell are still available to the user.

14. The invention of claim 1, wherein the count of graphic sides of the invention can be fewer than the count of data representations supplying the invention, with the invention rotating through high counts of data sets, while showing a limited number of graphic sides.

15. The invention of claim 1, wherein multiple data contents of the invention sides can be addressed, controlled, and used whether visible to the user or not.

16. The invention of claim 1, wherein multiple instances of the invention can be operated upon collectively, manipulated together in unison representing whole ranges of cells rotating together.

17. The invention of claim 1, wherein multiple instances of the invention as addressed together will have settings, programming methods and properties available to manipulate and address features of the associated, multiple instances of the invention.

18. The invention of claim 1, wherein upon changing the contents of one or more of the sides of the invention using a secondary source, such as but not limited to user direct entry, the invention may be set up to ultimately change the primary linked data directly to the original source and conversely the invention may be set up to prohibit changes to the primary linked data source.
